(19) United States
(12) Patent Application Publication
(10) Pub. No.: US 2021/0387401 A1
(43) Pub. Date: Dec. 16, 2021

(54) Methods and Systems for Additive Manufacturing

(71) Applicant: Adam Rumjahn, Berlin (DE)

(72) Inventor: Adam Rumjahn, Berlin (DE)

(73) Assignee: Orion Additive Manufacturing GmbH, Berlin (DE)

(21) Appl. No.: 16/903,203

(22) Filed: Jun. 16, 2020

(51) Int. Cl. B29C 64/118; B29C 64/393; B29C 64/209; B29C 64/245; B29C 64/227; B29C 64/295; B29C 64/25

(52) U.S. Cl. CPC B29C 64/118; B29C 64/393; B29C 64/209; B33Y 10/00; B29C 64/227; B29C 64/295; B29C 64/25; B29C 64/245

(57) ABSTRACT

Disclosed are methods and systems for additive manufacturing in a fused filament fabrication process with the application of thermal radiation whereby the thermal radiation is irradiated at an emission spectrum approximately the same as the absorbance spectrum of the modeling material. Three-dimensional objects are formed by depositing modeling material from a print head 104 onto a base 102 while thermal radiation is simultaneously applied through a print heating device 110 and a layer heating device 310 whereby the movements and devices are controlled by control signals from a controller 116. In one embodiment, the print head 104 is cooled by pressured gas and is disposed inside of the print environment while the linear motion guides 112 are disposed external to the print environment.

### CROSS-REFERENCE TO RELATED APPLICATION

This application claims the benefit of provisional patent application Ser. No. 62/863,288, filed 2019 Jun. 19 by the present inventor.

### FEDERALLY SPONSORED RESEARCH

None.

### SEQUENCE LISTING

None.

### BACKGROUND

This application relates to additive manufacturing systems, particularly methods and systems for fused filament fabrication with the application of thermal radiation.

### REFERENCES

The following is a tabulation of some prior art that presently appears relevant:

U.S. Patents

| Patent Number | Kind Code | Issue Date | Patentee |
|---|---|---|---|
| 6722872 | B1 | Apr. 20, 2004 | Swanson, Turley, |
| | | | Leavitt, Karwoski, |
| | | | LaBossiere, Skubic |
| 20170334137 | A1 | Nov. 23, 2017 | Nystrom, Mandel, |
| | | | Mantell, McConville |
| 9339972 | B2 | May 17, 2016 | Gordon |

Foreign Patent Documents

| Foreign Doc. | Cntry. | Kind | | App or |
|---|---|---|---|---|
| Nr. | Code | Code | Pub. Dt | Patentee |
| 102017122849 | DE | A1 | Oct. 2, 2017 | Fischer, Haerst, |
| | | | | Leonhardt, |
| | | | | Pammer |
| 102015111504 | DE | A1 | Jan. 19, 2017 | Walter, Popp, |
| | | | | Pfotzer, Okolo, |
| | | | | Tran-Mai |
| 2014678 | NL | B1 | Oct. 24, 2016 | Bruggeman, |
| | | | | Bruggeman |
| 2016063198 | WO | A1 | Apr. 28, 2016 | Beccuti |

### Nonpatent Literature Documents

KISHORE V., AJINJERU C., NYCZ A., POST B., LINDAHL J., KUNC V., DUTY C., Additive Manufacturing Magazine, “Infrared preheating to improve interlayer strength of big area additive manufacturing (BAAM) components” (March 2017)
SCHERILLO, GIUSEPPE & PETRETTA, MAURO & GALIZIA, MICHELE & LAMANNA, PIETRO & MUSTO, PELLEGRINO & MENSITIERI, GIUSEPPE. (2014). Thermodynamics of water sorption in high performance glassy thermoplastic polymers. Frontiers in chemistry. 2. 25. 10.3389/fchem.2014.00025.

### BACKGROUND/PRIOR ART

In additive manufacturing objects are formed by depositing modeling material in a controlled manner into layers such that a desired three dimensional shaped object can be created. This method of forming objects is sometimes referred to as additive manufacturing, 3D printing, fused deposition modeling, fused layer manufacturing or fused filament fabrication.

For extrusion based additive manufacturing using a fusible modeling material a fused filament fabrication (FFF) printer is often used but other methods are also possible. In a fused filament fabrication printer, fusible modeling material is usually fed into at least one print head in the form of filaments, granules, or rods.

The printer has at least one print head and at least one feeding device for feeding the fusible modeling material to the print head. The print head can be positioned by at least one axis of motion. The print head heats, melts and subsequently extrudes the melted modeling material from the print head. The melted modeling material can be deposited onto a base, a substrate, or onto previously deposited material where it is allowed to cool and solidify. Thus a fused filament fabrication modeled object is created with each deposited layer until the desired shape is obtained.

Fusible modeling materials are available in many different compositions, each having different properties such as melting temperature, glass transition temperature and coefficient of thermal expansion.

For those skilled in the art it is understood that thermal conditioning of the modeled object is usually applied to additive manufacturing systems to prevent possible problems such as warping, distortion, porosity and shrinking of the printed object as well as to improve its inter-layer bonding and overall mechanical strength. For crystalline or semi-crystalline polymers, thermal conditioning is required to maintain the temperature of the deposited modeling material above its glass transition temperature sufficiently long enough for crystallization to occur.

Some additive manufacturing systems use a thermally conditioned environment to deposit the modeling material to attempt to reduce mechanical tensions and warping due to thermal expansion or contraction. The thermally conditioned environment also attempts to maintain the printed object at an elevated temperature in order to control the crystallization process and/or improve the inter-layer bonding between the deposited layers of modeled material.

High performance polymers or engineering-grade polymers, such as semi-crystalline poly-ether-ether-ketone (PEEK), have recently been developed in formats suitable for use in additive manufacturing. This material is currently being developed by material producers Solvay, Victrex/Invibio, and Evonik Industries. The use of these materials as a modeling material for an extrusion based additive manufacturing has proven to be challenging due to the need for thermal conditioning at high temperatures. Additive manufacturing with high performance polymers offers several advantages over traditional materials like ABS and PLA including higher mechanical strength, higher temperature resistance, chemical resistance and dielectric strength. However, high-performance polymers also require special additive manufacturing systems to print with these materials.

In current extrusion based printers (including granule and rod extruders), the modeling material is deposited in a thermally conditioned environment such as an oven or a heated chamber as shown in U.S. Pat. No. 6,722,872 to Swanson (2004), which is heated to a predefined temperature for the duration of the printing process. We have found such a system moderately successful in printing with high performance polymers. The thermally conditioned environment is usually a heated chamber that heats the air and thus heating the object by means of convection. We have found that such heated chambers often require an excessive amount of heat and perform poorly due to the poor thermal transfer primarily by convection heating, resulting in weak inter-layer bonding.

Furthermore, the components internal to the thermally conditioned modeling environment, such as the print head and the motion control system, need to be thermally insulated to limit damage or malfunction. This adds to complexity to the design caused by additional components, weight, and friction, resulting in higher costs and restricted motion.

In other cases, the thermally conditioned environment is limited to lower temperatures to avoid damage or malfunction to the thermally exposed components, however, are unable to achieve desirable printing results compared to higher temperature modeling environments. This results in poor dimensional stability, poor inter-layer bonding and poor crystallization of crystalline or semi-crystalline polymers.

A system proposed by Kumovis (DE 102,017,122,849) uses a printer in which the extruder is cooled by a water-cooling system and a thermally conditioned heated chamber with laminar airflow. Such a system limits the exposure of internal components to high temperatures but still suffers from the disadvantages of convection heating mentioned previously. The print head is also cooled by water which presents a risk of damaging electronic components present in the system.

Some systems attempt to heat and fuse printed materials by introducing electromagnetic radiation to heat electromagnetically susceptible materials such as modeling materials filled with carbon-nanotubes (Essentium) or ferromagnetic fillers (BOND3D). The disadvantage of such a system is that they cannot process existing grades of high-performance thermoplastics alone without the introduction of electromagnetically susceptible materials. These systems have more complex parts and the need for a special material increases costs.

Another system proposed by U.S. Pat. No. 9,339,972 to Gordon (2016) attempts to improve the issue of inter-layer bonding by using laser diodes to direct heat at the layer interface. Such a system is complex and expensive due to the need for an array of multiple laser diodes placed around the nozzle in order to accompany heating of the modeled material in all orientations of printing. Additionally, such components need to be thermally insulated or cooled if operated in a high temperature environment.

The printing system assigned to Apium (DE 102,015,111,504) features a Cartesian style 3D printer in which a surface heating unit with selective heating zones which claims that the heat is transferred to the printed object by way of the air layer. This implies that heat is transferred via convection and thus results in poor heat transfer into the modeled material as mentioned previously. The patent also claims a local heating unit disposed on the print head for partially heating a printed object. It is noted here that the disclosed device claims a moveable surface heating unit opposite to the base and also a local heating unit, implying that the heating devices are all placed on the print head which produces a bulky and heavy print head, thus reducing the effective print area as the print head size needs to be accommodated for within the printing apparatus. More importantly, with only a heated base on the bottom and the other heaters on the top, the sides of the object are not heated. The manufactured system has worked marginally for printing with high performance polymers as the bulky heating device is used as a convection heating device and produces poor thermal conditioning of the modeled object, resulting in poor dimensional stability and poor inter-layer bonding.

In a system and method proposed by U.S. Pat. No. 201,703,341,37 to Nystrom, Mandel, Mantell, McConville (2017), a heater coupled to the print head is configured to heat a portion of the layer before the print head extrudes additional material onto the then heated layer. This proposed system attempts to increase the inter-layer bonding strength of the printed part, however, this system and method only attempts to heat a local region and is not sufficient for maintaining a sufficiently elevated temperature for high-performance polymers which exhibit high melting temperatures and high glass-transition temperatures.

In the research paper published by Kishore et al. (March 2017), Additive Manufacturing Magazine, “Infrared preheating to improve interlayer strength of big area additive manufacturing (BAAM) components”, the BAAM printer attempts to improve inter-layer bonding by fitting infrared heating lamps around the print head. The BAAM system is a large-sized open-air 3D printer and thus allows for much larger heating devices to be placed around the extruder head. However it lacks a heated chamber and heating such a large environment would be costly. Some improvements to inter-layer bonding were achieved by experimenting with heating lamps of different power potentials, varying heights of lamp placement and varying printing speed. Such a system would not be feasible for printing with high performance polymers as the material temperature must be maintained above glass transition temperatures above 150° C. for extended periods which cannot be produced in such a configuration.

It should be noted that for heat transfer by means of thermal radiation or infrared heating, the efficiency of the infrared heater depends on matching the emitted wavelength and the absorption spectrum of the material to be heated. None of the prior-art that cited thermal radiation, radiant heating or infrared heating mentioned the matching of the emission spectrum of the heaters to the absorption spectrum of the modeling material. It is possible that inventors in the prior-art did not apply thermal radiation in this manner due to limited knowledge and understanding of thermal radiation and photonics.

Therefore, a need exists in the field for novel methods and systems for building three-dimensional objects with a high quality result. More specifically, a need exists for an additive manufacturing system capable of building objects using high performance polymers with improved dimensional stability and inter-layer bonding.

### SUMMARY

The present invention relates to methods and systems for additive manufacturing, particularly methods and systems for fused filament fabrication with the application of thermal radiation. Three-dimensional objects are formed by depositing modeling material from a print head onto a base, a substrate, or onto previously deposited material as the print head and the base are moved relative to one another in a pattern determined by a control signal from a controller. In the disclosed methods and systems, thermal radiation is further applied to the object or to the deposited modeling material at an emission spectrum approximately the same as the absorbance spectrum of the modeling material.

In accordance to a disclosed method, the modeling material is deposited while thermal radiation is simultaneously applied to the deposited modeling material. The temperature of the surface of the object being formed can be subsequently measured and a parameter controlled by the controller is then modified to achieve a desired temperature measurement.

The modified parameter can be the amount of thermal radiation, the amount of cooling of the modeling material, the deposition rate or the printing speed or a combination thereof.

In accordance with another disclosed method, thermal radiation is applied locally to an area of previously deposited modeling material while additional material is simultaneously deposited to the thermally radiated area. The temperature of the surface of the object being formed is subsequently measured and a parameter controlled by the controller is then modified to achieve a desired temperature measurement. The modified parameter can be the amount of thermal radiation, the amount of cooling of the modeling material, the deposition rate or the printing speed or a combination thereof.

In accordance to one embodiment, an additive manufacturing system comprises at least one base, at least one print head, at least one nozzle for depositing modeling material, at least one device for feeding the modeling material, means for moving the print head relative to the base, and at least one print heating device for applying thermal radiation to the deposited modeling material. In this embodiment at least one additional layer heating device surrounds the at least one nozzle for applying thermal radiation locally to an area of previously deposited modeling material while additional material is subsequently deposited.

In accordance with the disclosed embodiment, an additive manufacturing print head comprises of a liquefier tube having at least one inlet and at least one outlet, a nozzle at the end of the at least one outlet for depositing modeling material, a heating element surrounding at least partially the at least one nozzle for liquefying the modeling material, a heat sink surrounding the liquefier tube for cooling the inlet area of the liquefier tube, and means for cooling the heat sink with a pressurized gas, and at least one layer heating device surrounding the nozzle for applying thermal radiation locally to an area of previously deposited modeling material while additional material is subsequently deposited.

There are a number of advantages to applying thermal radiation at an emission spectrum approximately the same as the absorbance spectrum of the modeling material. By applying heat transfer by thermal radiation in which the emission spectrum of the thermal radiation matches the absorbance spectrum of the deposited modeling material, the heat transfer is targeted directly to the modeled object and is not wasted in heating the air such as in a system comprising of a heated chamber where heat is transferred by convection. The application of thermal radiation in this manner improves the mechanical properties of the modeled object by reducing the amount of thermal and mechanical stresses, thus reducing warping and shrinking of the object. Furthermore, the application of thermal radiation in this manner improves the inter-layer bonding between deposited layers of modeling material. Additionally, by targeting the thermal radiation to the modeled object in this manner less heat is transferred to internally exposed components, thus limiting the damage of internal components due to exposure to heat.

### BRIEF DESCRIPTION OF THE DRAWINGS

Some embodiments are illustrated as an example and are not limited by the figures of the accompanying drawings, in which like references may indicate similar elements and in which:

FIG. 1A schematically illustrates an isometric view of one example of a system for additive manufacturing according to various embodiments of the present invention. This embodiment shows a Delta style motion system.

FIG. 1B schematically illustrates an isometric view of an alternative embodiment of a system for additive manufacturing. This embodiment shows a Cartesian style motion system, particularly an H-bot style motion system,

FIG. 2A schematically illustrates an isometric view of an example of a system where at least one print heating device is disposed adjacent to the base.

FIG. 2B schematically illustrates an isometric view of an example of a system in which at least one print heating device disposed adjacent to the base is complemented with at least one radiant reflective surface opposite to the at least one radiant heating device.

FIG. 2C schematically illustrates an isometric view of an example of a system in which a radiant barrier surrounds the base and the at least one print heating device.

FIG. 2D schematically illustrates an isometric view of an example of a system in which at least one flexible print heating device surrounds the base.

FIG. 3A schematically illustrates an isometric view of an example of a print head for additive manufacturing.

FIG. 3B schematically illustrates a front planar cross-section view of the print head shown in FIG. 3A. with previously deposited modeling material and the current layer of deposited modeling material

FIG. 3C schematically illustrates a bottom planar view of the print head shown in FIG. 3A.

### REFERENCE NUMERALS

100 Delta system
102 base
104 print head
106 material supply
108 feeding device
110 print heating device
111 Delta arms
112 linear motion guide
114 stepper motor
116 controller
118 CAD data
120 H-bot system
122 XY gantry
124 Z stage
200 radiant reflective surface
202 radiant barrier
204 flexible print heating device
302 liquefier tube
302A inlet of the liquefier tube
302B outlet of the liquefier tube
304 heat sink
306 nozzle
308 heating element
310 layer heating device
312 object surface temperature sensor
314 material cooling fluid supply
316 previously deposited modeling material
318 current layer of deposited modeling material

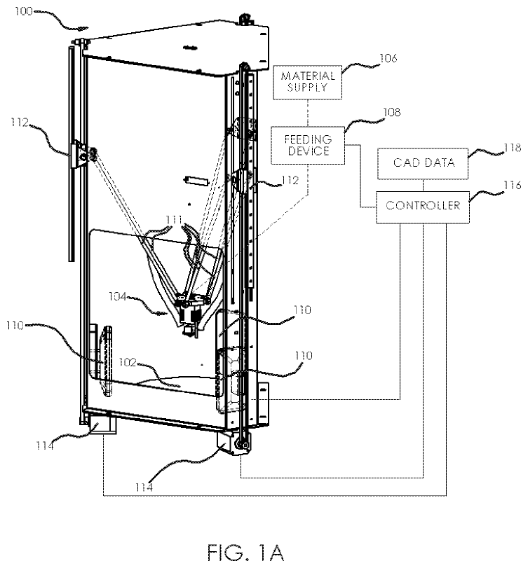

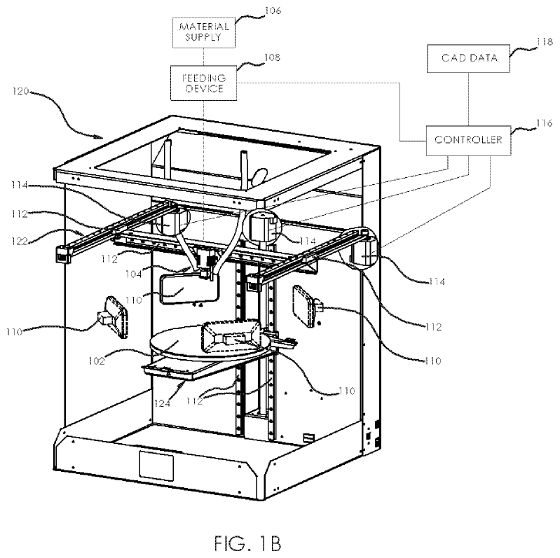

### DETAILED DESCRIPTION—FIGS. 1A, 2, 3—FIRST EMBODIMENT

The terminology used herein is for the purpose of describing particular embodiments only and is not intended to be limiting of the invention. As used herein, the term “and/or” includes any and all combinations of one or more of the associated listed items. As used herein, the singular forms “a”, “an” and “the” are intended to include the plural forms as well as the singular forms, unless the context clearly indicates otherwise. It will be further understood that the terms “comprises” and/or “comprising”, when used in this specification, specify the presence of stated features, steps, operations, elements, and/or components, but do not preclude the presence or addition of one or more other features, steps, operations, elements, components, and/or groups thereof.

Disclosed is a method and a system for building three-dimensional objects in a fused filament fabrication process while thermal radiation is simultaneously applied to the deposited modeling material, wherein the thermal radiation is irradiated at an emission spectrum approximately the same as the absorbance spectrum of the modeling material thus targeting heat transfer directly to the modeled object. The method and system enable the additive manufacturing of objects from modeling materials that have a high glass transition temperature that require that the deposited modeling material be maintained at an elevated temperature to achieve a high quality result. The modeling materials referred to in the disclosed method and system include high performance polymers such as polyaryletherketones (PAEK), polyetheretherketone (PEEK), polyetherketoneketone (PEKK), polyetherketone (PEK), polyphenylsulfone (PPSF), polyphenylsulfide, polyamide-imide, polyethersulfone, polyetherimide (PEI), polysulfone (PSU), polycarbonate (PC), poly(acrylonitrile butadiene styrene) (ABS), polymethylmethacrylate (PMMA), polyethyleneterephtalate (PET), polystyrene (PS), acrylonitrilestyrene acrylate, polypropylene (PP), polylactic acid (PLA), polyvinylalcohol (PVA), polyethylene (PE), polyoxymethylene, polyurethane (PU), copolymers of polyvinylalcohol and butenediolvinylalcohol and mixtures thereof, optionally filled with inorganic or organic fillers.

From the descriptions given on the disclosed methods and systems, numerous advantages from the embodiments become evident:
A. By using thermal radiation as opposed to convection we do not require a heated chamber as proposed by other systems.
B. The thermal radiation devices transfer heat to the modeled object primarily by thermal radiation, but can also transfer heat through conduction and convection.
C. Thermal radiation can be applied to open systems such as Big Area Additive Manufacturing (BAAM) systems.
D. Moreover, when thermal radiation is applied with an emission spectrum approximately the same as the absorbance spectrum of a modeling material, the efficiency increases and the thermal radiation can penetrate thermal energy into a modeled object as opposed to by convection which only applies heat to the surface of an object. This results in:
   a. lower energy required to heat the material;
   b. more even temperature distribution of the modeled objects;
   c. improved inter-layer bonding and thus improved overall mechanical strength of the modeled object;
   d. annealing and relieving of thermal stresses internally in the modeled object, minimizing the effects of shrinking or warping and thus improving the dimensional stability of the modeled object.

A first embodiment of an additive manufacturing system is shown in FIG. 1A. The Delta system 100 depicts a Delta style motion system comprising of a build platform or a base 102, a print head 104, a material supply 106 supplied with modeling material, a feeding device 108 to feed the modeling material from the material supply 106 to the print head 104, at least one print heating device 110, and means for moving the print head 104 relative to the base 102 in at least 3 axes of motion. The base 102 is of a predetermined shape, size and material. In this embodiment, the Delta arms 111 are attached to the print head 104 and provide means for motion relative to the base 102. The Delta arms 111 which make up part of the motion control system are disposed inside of the print environment and having means to connect to a linear motion guide 112 and to stepper motors 114 that are disposed external to the print environment. The stepper motors 114 are used for translating motion of the Delta arms 111 to the print head 104. The material supply 106 and the feeding device 108 are also disposed external to the print environment to decrease the weight of the print head 106 and avoid exposure to heat.

The at least one base 102 is placed at the bottom of the Delta system 100 and contains means to be heated up to a maximum temperature of 300° C. The base 102 is capable of irradiating thermal radiation at an emission spectrum approximately the same as the absorbance spectrum of the modeling material. The base 102 is made of a predetermined material in which the modeling material adheres to. A substrate can be placed on top of the base 102 in which modeling material can be deposited onto. The base 102 or the substrate can be made of a material such as aluminum but can also be made of other materials such as silicone rubber, steel, copper, ceramic, alumina, silicon nitride, alumina nitride, magnesium oxide, mica, glass, borosilicate glass, carbon fiber, fiberglass, quartz, quartz tungsten, gas-filled lamps, and others. Furthermore, the base 102 or the substrate can be made from either a radiant reflective material or a radiant transmissive material. For example, the substrate can also be made from a polymeric material such as polyetherimide (PEI), Kapton™, polycarbonate or other materials.

The system can be enclosed or open, as in the case of Big Area Additive Manufacturing (BAAM) systems where an enclosure of a large space is difficult to achieve. Optionally, fans or a supply of cooling fluid can be added to the printing environment of Delta system 100 for providing additional heating effects by convection. It is further proposed that a temperature sensor is placed inside the print environment to monitor the print environment temperature or the object surface temperature. In other embodiments, the Delta style motion system may be replaced with other types of motion systems used for additive manufacturing such as Cartesian, H-bot, CoreXY, Polar, SCARA, multi-axis robot arms, and others.

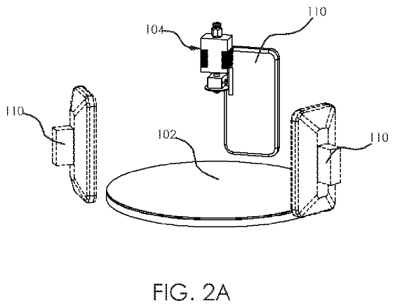

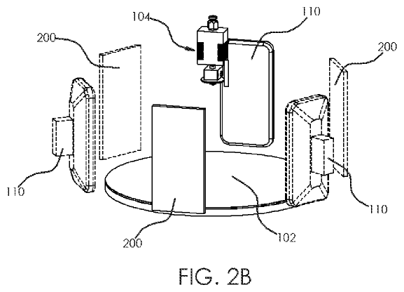

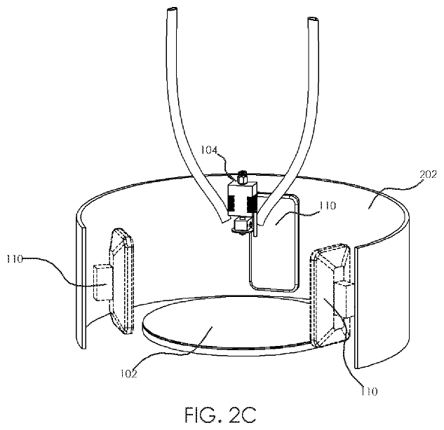

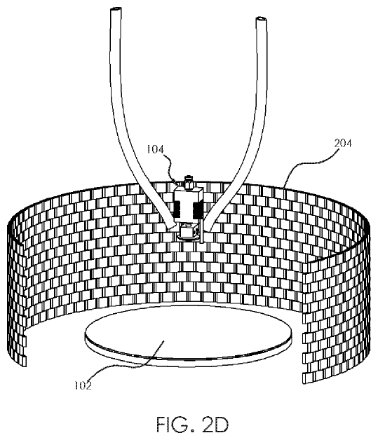

As shown in FIG. 2A the at least one print heating device 110 is disposed adjacent to the base 102 with means to attach to the inside structure of the print environment. The at least one print heating device 110 is fixed and does not move relative to the print environment. When more than one print heating device 110 is used, the devices are spatially arranged to surround the base 102 and may consist of several vertical rows to accommodate the heating of objects as large as the Delta system 100 can produce.

The print heating device 110 may be made of a ceramic material but may also be made of other materials such as metals, silicone, PEI, Kapton™, quartz, quartz tungsten, carbon fiber, gas-filled lamps or others. The print heating device 110 is made of a flat rectangular shape but may also be made of other shapes including square, round, curved, tubular, and others. The print heating device 110 applies thermal radiation to the modeling material deposited onto the base 102, wherein the thermal radiation is irradiated at an emission spectrum approximately the same as the absorbance spectrum of the modeling material. The print heating device 110 is regulated by a temperature sensor disposed inside of the print environment but may also have a temperature sensor in the print heating device 110 itself.

As shown in FIG. 2B the at least one print heating device 110 can be complemented with at least one radiant reflective surface 200, whereby the at least one radiant reflective surface 200 is disposed opposite of the at least one print heating device 110. The at least one radiant reflective surface 200 has means to be fixed to the print environment.

The at least one radiant reflective surface 200 is made from a radiant reflective material such as aluminum but can also be made of other materials such as composites with aluminum, silver, glass mirrors, and others. The at least one radiant reflective surface 200 is made of a flat rectangular shape but may also be made of other shapes including square, round, curved, tubular, and others.

The at least one radiant reflective surface 200 can be disposed close to the modeled object, thus targeting the thermal radiation closer to the object. Additionally, the radiant reflective surfaces 200 can be angled or positioned in a manner to optimize the amount of thermal radiation reflected to the modeled object.

Alternatively, as shown in FIG. 2C the at least one print heating device 110 can also be complemented with a radiant barrier 202 that surrounds at least partially a perimeter that encloses the base 102 and the at least one print heating device 110. The radiant barrier 202 can take the shape of the print environment or any free-form shape that encloses the base 102 and the at least one print heating device 110 inside the print environment. The radiant barrier 202 is made of a deformable material such as aluminum foil but can also be made of other materials including plain aluminum, composites with aluminum foils, silver, glass mirrors, and others.

Furthermore, the print heating device 110 can be replaced by other formats, shapes or sizes. For example, FIG. 2D shows a flexible print heating device 204 made from a flexible structure that surrounds at least partially the perimeter around the at least one base 102. The flexible print heating device 204 has means to be formed into the shape of the print environment or enclose a volume of the maximum printable object size. The flexible print heating device 204 is made from an assembly of small ceramic units in which a heating element passes through, but other materials are also possible such as silicone rubber, metal and others. The flattened shape of the flexible print heating device 204 is rectangular in shape but other shapes and sizes are also possible.

The flexible print heating device 204 is capable of distributing thermal radiation evenly and consistently around the modeled object. The flexible print heating device 204 also allows a smaller space to be enclosed and heated, thus reducing heat loss while applying thermal radiation closer to the modeled object.

It is conceivable that other embodiments may also incorporate the radiant reflective surfaces 200 of FIG. 2B, the radiant barrier 202 of FIG. 2C and the flexible print heating device 204 of FIG. 2C and any combination thereof.

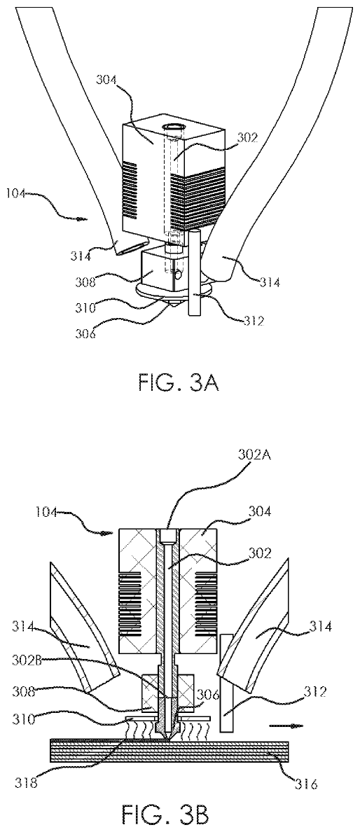

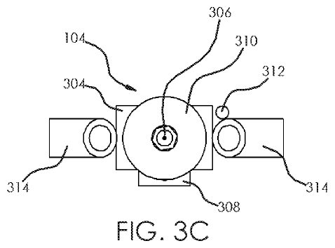

As shown in FIG. 3A the print head 104 comprises a liquefier tube 302, a heat sink 304, a nozzle 306 connected to an outlet of the liquefier tube 302B, a heating element 308 for liquefying the modeling material, a layer heating device 310, an object surface temperature sensor 312, and a material cooling fluid supply 314. The print head 104 receives the modeling material into an inlet of the liquefier tube 302A where it passes through the liquefier tube 304 to the outlet of the liquefier tube 302B. The modeling material is subsequently heated by the heating element 308 and liquefied so that it can be extruded out of the nozzle 306 onto the base 102, substrate, or over deposited modeling material.

The heat sink 304 surrounds the liquefier tube 302 and has means to receive a cooling fluid supply to cool the inlet portion of the liquefier tube 302. The heat sink 304 is made of an aluminum block but can be made of other thermally conductive materials whereby the thermal conductivity of the material is at least 200 W/mK. The heat sink 304 is made from a rectangular block with fins for dissipating heat whereby the total surface area is at least 120 cubic centimeters but can also be made of other shapes and sizes with a minimum surface area of 120 cubic centimeters. The advantage of the proposed heat sink is that it can operate in a high temperature environment without the need for cooling with more complex liquid cooling systems.

The layer heating device 310 surrounds the nozzle 306 and is placed at a predetermined distance from the bottom surface of the nozzle 306. The layer heating device 310 applies thermal radiation to the deposited modeling material, wherein the thermal radiation is irradiated at an emission spectrum approximately the same as the absorbance spectrum of the modeling material. The layer heating device 310 is made from a ceramic material but may also be made of other materials such as metals, steel, aluminum, copper, ceramic, alumina, silicon nitride, alumina nitride, magnesium oxide, mica, glass, borosilicate glass, carbon fiber, fiberglass, quartz, quartz tungsten, gas-filled lamps, and others. The layer heating device 310 made of a flat annular shape but may also be made of other shapes including square, round, curved, tubular, and others. Furthermore, the layer heating device 310 contains means for measuring the temperature of the device itself so that the heating can be controlled but the heating can also be controlled by other inputs such as by the object surface temperature sensor 312.

In FIG. 3B shows a cross-sectional view of the print head 104 depositing a current layer of deposited modeling material 318, and the object surface temperature sensor 312 for measuring the temperature of the top surface of a previously deposited modeling material 316. The material cooling fluid supply 314 delivers cooling fluid to cool the previously deposited modeling material 316 and to the current layer of deposited modeling material 318. The material cooling fluid supply 314 contains means for moderating the amount of cooling fluid supplied. The cooling fluid comprises pressurized air at ambient temperature but can also be of any pressurized gas such as hydrogen, nitrogen, oxygen, helium, carbon dioxide, and others. The material cooling fluid supply 314 is directed partially over the layer heating device 310 such that the cooling fluid is partially heated as it is applied to the printed object.

In FIG. 3C a bottom planar view of the print head 104 is shown. The layer heating device 310 is shown as an annular ring such that the inner diameter is slightly larger than the shape of the nozzle, thus allowing for the nozzle 306 to be inserted through the layer heating device and removed without interfering with the functionality of the heating device. The inside diameter of the layer heating device 310 is to be 10 mm but can also be of a smaller diameter. The outer diameter of the layer heating device 310 is to be 20 mm but can also be of a larger diameter.

In a disclosed method of additive manufacturing of three-dimensional objects, a modeling material with a known absorbance spectrum is deposited onto the base 102, substrate or onto previously deposited material. Thermal radiation is simultaneously applied to the deposited modeling material, wherein the thermal radiation is irradiated at an emission spectrum approximately the same as the absorbance spectrum of the modeling material. The thermal radiation can be applied by the base 102, print heating device 110, the layer heating device 310 or a combination thereof. During this process, the object surface temperature may be measured by the object surface temperature sensor 312 or an alternate temperature sensor disposed within the print environment, then through a control signal given by the controller 116 the rate of thermal radiation may be modified so that the object surface will reach a determined temperature. If the object surface temperature is higher than the desired temperature, the controller 116 will cease the application of thermal radiation and cooling may be applied to reach the desired temperature. The desired temperature may be reached through a closed-loop control whereby the controller 116 controls the amount of thermal radiation and cooling until a later temperature reading results in the desired temperature. Alternatively, the thermal radiation and cooling may be applied in a predictive manner such that the controller 116 predicts the amount of thermal radiation to apply to the object to reach the desired temperature. When the modeled object is complete, thermal radiation may further be applied for a predetermined period of time to allow for annealing.

In another disclosed method of additive manufacturing of three-dimensional objects, modeling material with a known absorbance spectrum is deposited onto the base 102, substrate or onto previously deposited material in a predetermined area while the layer heating device 310 applies thermal radiation locally to an area where the modeling material is simultaneously deposited, wherein the thermal radiation irradiates an emission spectrum approximately the same as the absorbance spectrum of the modeling material. During this process, the object surface temperature sensor 312 may measure the temperature of the previously deposited modeling material 316, then through a control signal given by the controller 116 the rate of thermal radiation may be modified so that the top surface of the previously deposited modeling material 316 will reach a predetermined temperature. If the object surface temperature is higher than the desired temperature, the controller 116 will cease the application of thermal radiation and the material cooling fluid supply 314 may be activated to supply cooling fluid to the previously deposited modeling material 316 until the desired temperature is reached. The desired temperature may be reached through a closed-loop control whereby the controller 116 controls the amount of thermal radiation and cooling until a later temperature reading results in the desired temperature. Alternatively, the thermal radiation and cooling may be applied in a predictive manner such that the controller 116 predicts the amount of thermal radiation to apply to the object to reach the desired temperature.

In applying thermal radiation, whereby the thermal radiation is irradiated at an emission spectrum approximately the same as the absorbance spectrum of the modeling material, it should be noted that the absorbance spectrum poly-ether-ether-ketone (PEEK) is known to have a wavelength approximately between 5-10 micrometers (Scherillo et al. (2014). Thermodynamics of water sorption in high performance glassy thermoplastic polymers. Frontiers in chemistry. 2. 25. 10.3389/fchem.2014.00025). Hence for PEEK material, a suitable heater for the base 102, the print heating device 110 and the layer heating device 310 should have an emission spectrum with a similar wavelength. Some ceramic heaters that have been found to have an emission spectrum with a wavelength range between 2-10 micrometers have been implemented in the disclosed embodiment for building objects with PEEK modeling material with successful results. In experiments conducted using the disclosed embodiments, the resulting tensile strength of PEEK in the vertical orientation was tested to be at least 50 MPa, a notable improvement from 10 MPa when no thermal radiation was applied, thus illustrating the effect of the proposed embodiments on improving inter-layer bonding.

It should be noted that further spectral analyses for other modeling materials need to be performed to determine their respective absorbance spectrum so that heating devices with a similar emission spectrum can be specified for each modeling material.

### OPERATION—FIG. 1A, 2, 3—FIRST EMBODIMENT

The manner of operating the disclosed additive manufacturing Delta system 100 is similar to that for other fused filament fabrication based additive manufacturing systems currently in use with the additional application of thermal radiation. Namely, three-dimensional objects are formed by depositing modeling material from the print head 104 under the control of a controller 116.

The controller 116 receives CAD data 118 defining the model to be formed and consequently produces signals that control the print head 104 and other devices of the Delta system 100. The drive signals are sent to the stepper motors 114 to control the movement of the print head 104 relative to the base 102 as well as to the feeding device 108 which supplies the modeling material to the print head 104. The controller 116 further controls the feed rate of the feeding device as well as the temperature of the heating element 308 that liquefies the modeling material. The modeling material is deposited onto the base 102 or onto previously deposited modeling material in a layer-by-layer fashion. By controlling the feed rate of the deposition while moving the print head 104 over the base 102 in a predetermined pattern by the CAD data, a three-dimensional object which resembles a CAD model is created.

In the process of building an object using the Delta system 100, the base 102 is stationary while the print head 104 can move freely in at least 3 axes of motion relative to the base 102. To build an object, the nozzle 306 of the print head 104 is positioned in close proximity above the base 102 whereby modeling material 306 is deposited onto the base 102, substrate or over previously deposited material. The Delta arms 111 will move the print head 104 in at least 3 axes of motion so that successive layers of material can be deposited until a three-dimensional object is formed. During the build process, the controller 116 may heat the base 102 to improve the adhering of the modeled object to the base 102 or to the substrate placed over top of the base 102. Additionally, the controller 116 can activate the at least one print heating device 110 and the layer heating device 310 to apply thermal radiation to the deposited modeling material. The thermal radiation, which is irradiated at an emission spectrum approximately the same as the absorbance spectrum of the modeling material, aids in thermally conditioning the deposited modeling material 316 to relieve thermal stresses, reduce the effects of shrinking and improve inter-layer bonding between the previously deposited modeling material 316 and the current layer of deposited modeling material 318.

As modeling material is deposited, the object may be simultaneously cooled by the material cooling fluid supply 314. The object surface temperature sensor 312 monitors the temperature of the deposited modeling material. The controller 116 will modify the rate of thermal radiation accordingly such that the object surface reaches a predetermined temperature in either a predicted manner or a monitored manner. Additionally, the controller 116 can modify the rate of cooling provided by the material cooling fluid supply 314 such that the object surface reaches a predetermined temperature in either a predicted manner or a monitored manner.

To finalize the build process, when the formation of the three-dimensional object is complete, the Delta system 100 may continue to apply thermal radiation to the modeled object for a predetermined amount of time to further relieve thermal stresses and to aid in the crystallization of crystalline and semi-crystalline polymers. The duration of this process typically lasts 2 hours but may last up to 48 hours or more, in which time the thermal radiation may be gradually decreased until being completely deactivated.

### DETAILED DESCRIPTION—FIG. 1B—ALTERNATIVE EMBODIMENTS

Those skilled in the art will recognize that enumerable modifications may be made to the deposition forming process to be carried out by the system and to the previously disclosed embodiment of the system. For example, there exist many motion system configurations in which the print head 104 can move in at least 3 axes relative to the base 102 in a Cartesian coordinate system. Some examples include Cartesian systems where the print head 104 is mounted to a gantry that can move in the X-axis only, or X-axis and Y-axis only, or in the X-axis and Z-axis only, or with any other combination of one or more axes. Other systems also include H-bot, CoreXY, Polar, SCARA, multi-axis robot arms, and others.

An alternative embodiment of an additive manufacturing system is shown in FIG. 1B. The H-bot system 120 depicts an H-bot style motion system whereby the print head 104 has means to connect to an XY gantry 122 and the base 102 is placed on a platform or Z-stage 115 that is movable along a vertical Z-axis. The XY gantry 122 comprises a single linear motion guide 112 for the horizontal X-axis and means to connect to two linear motion guides for movement in the Y-axis. The XY gantry 122 is disposed inside of the print environment and contains means to connect to two stepper motors 114, disposed externally to the print environment, for controlling motion of the print head 104 in the XY plane.

The Z stage 124 is attached to two linear motion guides 112 and contains means to be driven along the vertical Z axis by a stepper motor 114. The linear motion guides 112 and the means of driving the Z stage 124 are disposed inside the print environment while the stepper motor is disposed external to the print environment.

The at least one print heating device 110 is disposed adjacent to the base 102 with means to attach to the inside structure of the print environment. The at least one print heating device 110 is fixed and does not move relative to the print environment. When more than one print heating device 110 is used, the devices are spatially arranged to surround the base 102 and may consist of several vertical rows to accommodate the heating of objects as large as the H-bot system 120 can produce.

Furthermore, this alternative embodiment may also incorporate the radiant reflective surfaces 200 of FIG. 2B, the radiant barrier 202 of FIG. 2C and the flexible print heating device 204 of FIG. 2C and any combination thereof.

### OPERATION—FIG. 1B

The manner of operating the disclosed additive manufacturing H-bot system 120 is similar to that of the previously disclosed Delta system 100. Apart from the following operational steps mentioned in the succeeding sections below, the operation of the H-bot system 120 is understood to be the same as the aforementioned operation of the Delta system 100.

In the process of building an object using the H-bot system 120, the base 102 is attached to a Z stage 124 that can move vertically in the Z-axis while the print head 104 is attached to the XY, which is capable of moving the print head 104 in an XY plane.

To build an object, the base 102 is moved up so that the nozzle 306 of the print head 104 is positioned in close proximity above the base 102. The modeling material 306 is then deposited onto the base 102, substrate or over previously deposited material. The Z stage 124 will move the base 102 down so that successive layers of material can be deposited until a three-dimensional object is formed. During this process, the controller 116 can activate the at least one print heating device 110 and the layer heating device 310 to apply thermal radiation to the deposited modeling material 316 and to the current layer of deposited modeling material 318 respectively. The thermal radiation, which is irradiated at an emission spectrum approximately the same as the absorbance spectrum of the modeling material, aids in thermally conditioning the deposited modeling material 316 to relieve thermal stresses, reduce the effects of shrinking and improve inter-layer bonding between the previously deposited modeling material 316 and the current layer of deposited modeling material 318.

### CONCLUSION, RAMIFICATIONS AND SCOPE

Accordingly, the disclosed embodiments reveal methods and systems for additive manufacturing in a fused filament fabrication process in which thermal radiation, when applied such that the emission spectrum is approximately the same as the absorption spectrum of the modeling material, can produce a high quality object with improved dimensional stability and inter-layer bonding.

Furthermore, from the descriptions given on the disclosed methods and systems, numerous advantages from the embodiments become evident:
The print head can be cooled by a pressurized gas such as air as opposed to being cooled by liquid. This results in a simple, cheap design that avoids the risks of mixing liquids near electronic devices.
Heating of modeled objects can be evenly distributed from all directions; top, bottom and sides.
Less energy and heat are required for building an object.
Heat transfer is applied primarily through thermal radiation but also provides the inherent benefit of heat transfer by conduction and convection wherever possible.
An enclosed chamber is not required such as those typically used for convection heating systems.
Thermal isolation of the motion control components and other critical components is minimized or avoided due to the heat being targeted to the object rather than to the whole print environment.
The methods and systems can be applied to open and larger print environments, for example the Big Area Additive Manufacturing (BAAM) system.
By applying thermal radiation wherein the emission spectrum is approximately the same as the absorbance spectrum of the modeling material, modeled objects can be heated consistently to elevated temperatures above their glass transition temperatures, furthermore;
   improving crystallinity in crystalline and semicrystalline thermoplastics;
   annealing the material to relieve thermal stresses, thus reducing the effects of shrinking and warping; and
   improving the inter-layer bonding of modeled objects, thus improving the mechanical strength of the modeled object.

Although the description above contains many specifics, these should not be construed as limiting the scope of the embodiments but as merely providing illustrations of some of several embodiments. For example, the thermal radiation devices can have other shapes and be made of other materials such as silicone rubber, steel, aluminum, copper, ceramic, alumina, silicon nitride, alumina nitride, magnesium oxide, mica, glass, borosilicate glass, carbon fiber, fiberglass, quartz, quartz tungsten, gas-filled lamps, and others. Furthermore, the motion system for generating relative motion between the print head and the base may also encompass other controlled motion systems such as XY gantry (traditional Cartesian, H-bot, CoreXY), XZ gantry (for example Prusa and Lulzbot 3D printers), polar coordinate systems, multi-axis robot arms (for example Kuka and ABB 6-axis robot arms), and others.

Thus the scope of the embodiments should be determined by the appended claims and their legal equivalents, rather than by the examples given.

What is claimed is:

1. A method of additive manufacturing of three-dimensional objects comprising the steps of:
depositing a modeling material, the modeling material having a predetermined absorbance spectrum;
simultaneously applying thermal radiation to the deposited modeling material;
wherein the thermal radiation irradiates an emission spectrum approximately the same as the absorbance spectrum of the modeling material.

2. A method according to claim 1, further comprising means for measuring the temperature effect of applied thermal radiation.

3. A method according to claim 2, further comprising modifying a rate of thermal radiation such that the object surface reaches a predetermined temperature.

4. A method according to claim 2, further comprising modifying a rate of cooling such that the object surface reaches a predetermined temperature.

5. The method according to claim 1, further maintaining the application of thermal radiation to the modeled object for a predetermined period after completing the steps of the method of claim 1.

6. The method according to claim 1, wherein the modeling material comprises of a high-performance plastic wherein the high-performance plastic is made from at least one component that consists of polyaryletherketones (PAEK), polyetheretherketone (PEEK), polyetherketoneketone (PEKK), polyetherketone (PEK), polyphenylsulfone (PPSF), polyphenylsulfide, polyamide-imide, polyethersulfone, polyetherimide (PEI), polysulfone (PSU), polycarbonate (PC), poly(acrylonitrile butadiene styrene) (ABS), polymethylmethacrylate (PMMA), polyethyleneterephtalate (PET), polystyrene (PS), acrylonitrilestyrene acrylate, polypropylene (PP), polylactic acid (PLA), polyvinylalcohol (PVA), polyethylene (PE), polyoxymethylene, polyurethane (PU), copolymers of polyvinylalcohol and butenediolvinylalcohol and mixtures thereof, optionally filled with inorganic or organic fillers.

7. A method additive manufacturing of three-dimensional objects comprising the steps of:
depositing a modeling material of a predetermined area, the modeling material having a predetermined absorbance spectrum;
applying thermal radiation locally to an area where the modeling material is simultaneously deposited; wherein the thermal radiation irradiates an emission spectrum approximately the same as the absorbance spectrum of the modeling material.

8. A method according to claim 7, further comprising means for measuring the temperature effect of the locally applied thermal radiation.

9. A method according to claim 8, further comprising modifying the amount of thermal radiation until the object surface reaches a predetermined temperature.

10. A method according to claim 8, further comprising activating a device for cooling of the object surface until a predetermined temperature is reached.

11. The modeling material of claim 7, wherein the provided modeling material comprises of a high-performance plastic wherein the high-performance plastic is made from at least one component that consists of polyaryletherketones (PAEK), polyetheretherketone (PEEK), polyetherketoneketone (PEKK), polyetherketone (PEK), polyphenylsulfone (PPSF), polyphenylsulfide, polyamide-imide, polyethersulfone, polyetherimide (PEI), polysulfone (PSU), polycarbonate (PC), poly(acrylonitrile butadiene styrene) (ABS), polymethylmethacrylate (PMMA), polyethyleneterephtalate (PET), polystyrene (PS), acrylonitrilestyrene acrylate, polypropylene (PP), polylactic acid (PLA), polyvinylalcohol (PVA), polyethylene (PE), polyoxymethylene, polyurethane (PU), copolymers of polyvinylalcohol and butenediolvinylalcohol and mixtures thereof, optionally filled with inorganic or organic fillers.

12. A system for additive manufacturing of three-dimensional objects comprising of:
at least one base;
at least one print head;
the at least one base being of a predetermined shape, size and material;
the at least one print head having at least one nozzle for depositing a modeling material onto the at least one base and over previously deposited modeling material, the modeling material having a predetermined absorbance spectrum;
means to move the at least one print head relative to the at least one base;
means to heat the at least one base;
at least one device for feeding at least one modeling material into the at least one print head;
at least one print heating device for applying thermal radiation to the deposited modeling material, said print heating device disposed adjacent to the at least one base;
characterized in that: the at least one print heating device irradiates thermal radiation at an emission spectrum approximately the same as the absorbance spectrum of the modeling material.

13. The at least one base of claim 12, wherein the base irradiates thermal radiation at an emission spectrum approximately the same as the absorbance spectrum of the modeling material.

14. The at least one base of claim 12, wherein the base comprises a radiant reflective material.

15. The at least one print head of claim 12, further comprising at least one layer heating device for applying thermal radiation locally to an area of the deposited modeling material, said layer heating device surrounding the at least one nozzle, characterized in that:
the at least one layer heating device irradiates thermal radiation at an emission spectrum approximately the same as the absorbance spectrum of the modeling material.

16. The modeling material of claim 12, wherein the provided modeling material comprises of a high-performance plastic wherein the high-performance plastic is made from at least one component that consists of polyaryletherketones (PAEK), polyetheretherketone (PEEK), polyetherketoneketone (PEKK), polyetherketone (PEK), polyphenylsulfone (PPSF), polyphenylsulfide, polyamide-imide, polyethersulfone, polyetherimide (PEI), polysulfone (PSU), polycarbonate (PC), poly(acrylonitrile butadiene styrene) (ABS), polymethylmethacrylate (PMMA), polyethyleneterephtalate (PET), polystyrene (PS), acrylonitrilestyrene acrylate, polypropylene (PP), polylactic acid (PLA), polyvinylalcohol (PVA), polyethylene (PE), polyoxymethylene, polyurethane (PU), copolymers of polyvinylalcohol and butenediolvinylalcohol and mixtures thereof, optionally filled with inorganic or organic fillers.

17. The system of claim 12, wherein the at least one print heating device further comprises a flexible structure that surrounds at least partially a perimeter around the at least one base.

18. The system of claim 12, further comprising a radiant barrier surrounding at least partially a perimeter that encloses the base and the at least one print heating device.

19. The at least one print head of claim 12, further comprising a heat sink of a predetermined shape for cooling a portion of the print head, said heat sink is cooled by a pressured gas.

20. The at least one print head of claim 12, further comprising means for measuring the temperature effect of the applied thermal radiation.
